(19) United States
(12) Patent Application Publication
(10) Pub. No.: US 2023/0220932 A1
(43) Pub. Date: Jul. 13, 2023

(54) CABLE TRANSIT

(71) Applicant: CAPE Industries, LLC, Kansas City, MO (US)

(72) Inventors: Allen Todd GIBSON, Kansas City, MO (US); Solomon Otto WHITAKER, Kansas City, MO (US); Melissa A. VER MEER, Overland Park, KS (US)

(73) Assignee: CAPE Industries, LLC, Kansas City, MO (US)

(21) Appl. No.: 18/150,286

(22) Filed: Jan. 5, 2023

Related U.S. Application Data
(60) Provisional application No. 63/266,546, filed on Jan. 7, 2022.

(51) Int. Cl. F16L 5/02

(52) U.S. Cl. CPC F16L 5/02

(57) ABSTRACT

A multi-cable transit may include a plurality of modules disposed within the frame assembly; each of the plurality of modules comprising: an upper housing, a lower housing disposed opposite the upper housing; and a plurality of upper layers and a plurality of lower layers disposed between the upper housing and the lower housing; and a compression wedge unit connected between the frame assembly and the plurality of modules, wherein expansion of the compression wedge unit compresses the plurality of modules within the frame assembly to form a gas-tight seal within the plurality of modules. A single cable transit may include a pair of component halves, each of the pair of component halves comprising: a u-shaped body having a curved outer surface and contoured inner surface; a plurality of interlocking layers; and a compression member configured to axially compress the u-shaped body.

### PRIORITY DATA

This U.S. non-provisional patent application claims priority to U.S. Provisional Patent App. No. 63/266,546, filed on Jan. 7, 2022, which is hereby incorporated by reference herein.

### TECHNICAL FIELD

The disclosed subject matter relates generally to cable transits and more particularly, to cable transits having compressible modules.

### SUMMARY

In some embodiments, the disclosed subject matter described herein relate to a multi-cable transit including: a frame assembly; a plurality of modules disposed within the frame assembly; each of the plurality of modules including: an upper housing; a lower housing disposed opposite the upper housing; and a plurality of upper layers and a plurality of lower layers disposed between the upper housing and the lower housing; and a compression wedge unit connected between the frame assembly and the plurality of modules, wherein expansion of the compression wedge unit compresses the plurality of modules within the frame assembly to form a gas-tight seal within the plurality of modules.

In some embodiments, the disclosed subject matter described herein relate to a multi-cable transit, wherein each of the plurality of upper layers and the plurality of lower layers including alternating side ribs and side channels configured to restrain axial movement of the plurality of upper layers and the plurality of lower layers.

In some embodiments, the disclosed subject matter described herein relate to a multi-cable transit, further including a plurality of air gaps formed between the plurality of upper layers, the plurality of lower layers, the upper housing, and the lower housing.

In some embodiments, the disclosed subject matter described herein relate to a multi-cable transit, wherein the plurality of upper layers and the plurality of lower layers including a set of protrusions configured to restrain rotational movement of the plurality of upper layers and the plurality of lower layers.

In some embodiments, the disclosed subject matter described herein relate to a multi-cable transit, wherein the upper housing includes a plurality of upper channels, and wherein the lower housing includes a plurality of lower channels.

In some embodiments, the disclosed subject matter described herein relate to a multi-cable transit, wherein the plurality of modules including a core connected between the plurality of upper layers and the plurality of lower layers.

In some embodiments, the disclosed subject matter described herein relate to a multi-cable transit, wherein the core includes: a central cylinder having an exterior surface; and a plurality of ribs disposed along the exterior surface.

In some embodiments, the disclosed subject matter described herein relate to a multi-cable transit, further including a stay plate demountably attached between the plurality of modules.

In some embodiments, the disclosed subject matter described herein relate to a multi-cable transit, wherein the stay plate includes a central planar member having a plurality of ridges extending in opposite directions from the central planar member.

In some embodiments, the disclosed subject matter described herein relate to a multi-cable transit, wherein the compression wedge unit includes: a central receiving module including: a top receiver configured to receive and retain a top wedge insert; a bottom receiver configured to receive and retain a bottom wedge insert, the bottom receiver disposed opposite the top receiver; a front receiver configured to receive and retain a front wedge insert, the front receiver partially disposed between the top receiver and the bottom receiver; and a back receiver configured to receive and retain a back wedge insert, the back receiver disposed opposite the front receiver, the back receiver partially disposed between the top receiver and the bottom receiver; a set of dual-threaded bolts configured to engage the front wedge insert; and a set of nuts configured to engage the back wedge insert and the set of dual-threaded bolts, wherein rotation of the set of dual-threaded bolts urges the front receiver and the back receiver towards each other, thereby expanding the compression wedge unit which compresses the plurality of modules within the frame assembly to form a gas-tight seal within the plurality of modules.

In some embodiments, the disclosed subject matter described herein relate to a single cable transit including: a pair of component halves having a central axis, each of the pair of component halves including: a u-shaped body having a curved outer surface and contoured inner surface; and a compression member configured to axially compress the u-shaped body, whereby axial compression of the u-shaped body urges the curved outer surface away from the central axis and urges the contoured inner surface towards the central axis, thereby providing a gas-tight seal between the pair of component halves.

In some embodiments, the disclosed subject matter described herein relate to a single cable transit, further including a plurality of interlocking layers connected to the u-shaped body along the contoured inner surface.

In some embodiments, the disclosed subject matter described herein relate to a single cable transit, wherein the contoured inner surface includes an inner surface contours and a first set of notches configured to interlock with the plurality of interlocking layers.

In some embodiments, the disclosed subject matter described herein relate to a single cable transit, wherein the u-shaped body includes: a front surface; a back surface opposite the front surface; and a plurality of holes formed through the u-shaped body between the front surface and the back surface.

In some embodiments, the disclosed subject matter described herein relate to a single cable transit, wherein the compression member includes: a pair of front plates; a pair of back plates connected to the pair of front plates; and a plurality of bolts connected between the pair of front plates and the pair of back plates; wherein the plurality of bolts are disposed withing the plurality of holes.

In some embodiments, the disclosed subject matter described herein relate to a single cable transit, wherein the pair of back plates include a plurality of internally threaded holes to mate with the plurality of bolts.

In some embodiments, the disclosed subject matter described herein relate to a single cable transit, wherein each of the pair of front plates include a first curved projection; and wherein each of the pair of back plates include a second curved projection.

In some embodiments, the disclosed subject matter described herein relate to a single cable transit, wherein the u-shaped body includes: a front curved channel extending along the front surface between the plurality of holes, the front curved channel configured to receive the first curved projection; and a back curved channel extending along the back surface between the plurality of holes, the back curved channel configured to receive the second curved projection.

In some embodiments, the disclosed subject matter described herein relate to a single cable transit, further includes a core connected between the plurality of interlocking layers.

In some embodiments, the disclosed subject matter described herein relate to a single cable transit, wherein the core includes: a central cylinder having an exterior surface; and a plurality of ribs disposed along the exterior surface.

### BRIEF DESCRIPTION OF THE FIGURES

The disclosed subject matter is described herein with reference to the following drawing figures, with greater emphasis being placed on clarity rather than scale.

FIG. 1 is a front perspective view of an embodiment of a multi-cable transit.

FIG. 2 is a front view of an embodiment of a multi-cable transit.

FIG. 3 is a top view of an embodiment of a multi-cable transit.

FIG. 4 is a side view of an embodiment of a multi-cable transit.

FIG. 5 is a front perspective view of an embodiment of a frame assembly.

FIG. 6 is a front perspective view of an embodiment of a frame assembly.

FIG. 7 is a rear perspective view of an embodiment of a frame assembly.

FIG. 8 is a perspective view of an embodiment of a stay plate.

FIG. 9 is a perspective view of an embodiment of an assembled module.

FIG. 10 is a perspective view of an embodiment of a module housing.

FIG. 11 is a perspective view of an embodiment of a module layer.

FIG. 12 is an exploded view of an embodiment of a partially assembled module.

FIG. 13 is an exploded view of an embodiment of a partially assembled module.

FIG. 14 is a perspective view of an embodiment of a core.

FIG. 15 is a cross-section view of an embodiment of a housing with layers.

FIG. 16 is a side view of an embodiment of a module.

FIG. 17 is an exploded view of an embodiment of a compression wedge unit.

FIG. 18 is a cross-sectional view of an embodiment of a compression wedge unit.

FIG. 19 is a cross-sectional view of an embodiment of a central receiving module.

FIG. 20 is a detailed view of an embodiment of the central receiving module.

FIG. 21 is a detailed view of an embodiment of the central receiving module.

FIG. 22 is a perspective view of an embodiment of a top wedge insert.

FIG. 23 is a perspective view of an embodiment of a bottom wedge insert.

FIG. 24 is a perspective view of an embodiment of a front wedge insert.

FIG. 25 is a cross-sectional view of an embodiment of a front wedge insert.

FIG. 26 is a side view of an embodiment of a dual-threaded bolt.

FIG. 27 is a partial cross-sectional view of an embodiment of a compression wedge unit.

FIG. 28 is a perspective view of an embodiment of a back wedge insert.

FIG. 29 is a cross-sectional view of an embodiment of a back wedge insert.

FIG. 30 is a side view of an embodiment of a nut.

FIG. 31 is a cross-sectional view of an embodiment of a nut.

FIG. 32 is a partial cross-sectional view of a nut and a back wedge insert.

FIG. 33 is a perspective view of an embodiment of a module.

FIG. 34 is a is a perspective view of an embodiment of a stay plate.

FIG. 35 is a side view of an embodiment of a stay plate.

FIG. 36 is a front perspective view of an embodiment of a single cable transit.

FIG. 37 is a front view of an embodiment of a single cable transit.

FIG. 38 is an exploded view of an embodiment of one of a pair of component halves of the single cable transit.

FIG. 39 is a perspective view of an embodiment of one of a pair of front plates.

FIG. 40 is a perspective view of an embodiment of one of a pair of back plates.

FIG. 41 is a perspective view of an embodiment of a u-shaped body.

FIG. 42 is a cross section view of an embodiment of a u-shaped body.

### DETAILED DESCRIPTION

As required, detailed aspects of the disclosed subject matter are disclosed herein; however, it is to be understood that the disclosed embodiments are merely exemplary of the disclosed subject matter, which may be embodied in various forms. Therefore, specific structural and functional details disclosed herein are not to be interpreted as limiting, but merely as a basis for the claims and as a representative basis for teaching one skilled in the art how to variously employ the disclosed technology in virtually any appropriately detailed structure.

Although the disclosed subject matter has been disclosed with reference to various particular embodiments, it is understood that equivalents may be employed and substitutions made herein without departing from the scope of the disclosed subject matter as recited in the claims.

Certain terminology will be used in the following description, and are shown in the drawings, and will not be limiting. For example, back, front, top, bottom, up, down, front, back, right and left refer to the disclosed subject matter as orientated in the view being referred to. The words, “upwardly,” downwardly,” “inwardly,” and “outwardly” refer to directions toward and away from, respectively, the geometric center of the aspect being described and designated parts thereof. Forwardly and rearwardly are generally in reference to the direction of travel, if appropriate. Said terminology will include the words specifically mentioned, derivatives thereof and words of similar meaning.

The detailed description includes the disclosure of numerical ranges. Numerical ranges should be construed to provide literal support for claim limitations reciting only the upper value of a numerical range and provide literal support for claim limitations reciting only the lower value of a numerical range.

The disclosed subject matter will now be described with reference to the drawing figures, in which like reference numerals refer to like parts throughout. For purposes of clarity in illustrating the characteristics of the present disclosed subject matter, proportional relationships of the elements have not been maintained in the figures. In some cases, the sizes of certain small components have been exaggerated for illustration.

A cable transit disclosed in the present application provides a water-tight, gas-tight and environmental seal around cylindrical objects, such as cables, conduits, and/or pipes, between two sides of a physical barrier having a structural opening. Although the term cable transit is used herein, the transit may be used with other objects such as pipes, conduits, and other objects having a general cylindrical shape. The cable transit provides similar or higher performance characteristics of the physical barrier itself. The cable transit may provide a gas-tight seal up to 2.5 bar, and a water-tight seal up to 5 bar. The cable transit may be rated for blast loads greater than 10 psi for over 60 milliseconds. The cable transit may provide cable retention performance which meets the standards defined in EN 50262 for Type B cable glands, IEC 62444, IEC 60079-0 (for hazardous applications), and the minimum “pull force” in accordance with UL 514B, Table 27. The cable transit may provide a fire, smoke and temperature barrier to meet or exceed 2 to 4 hours in accordance with UL 1479, and ABS, DNV and USCG requirements for A, H and jet-fire ratings. In addition, the cable transit may provide noise and vibration dampening between the physical barrier.

Multi-Cable Transit

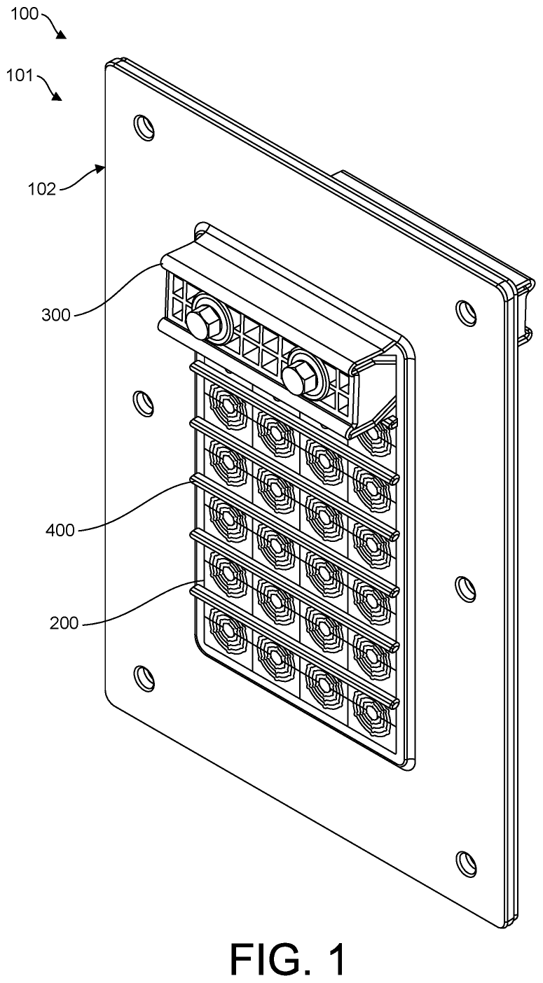

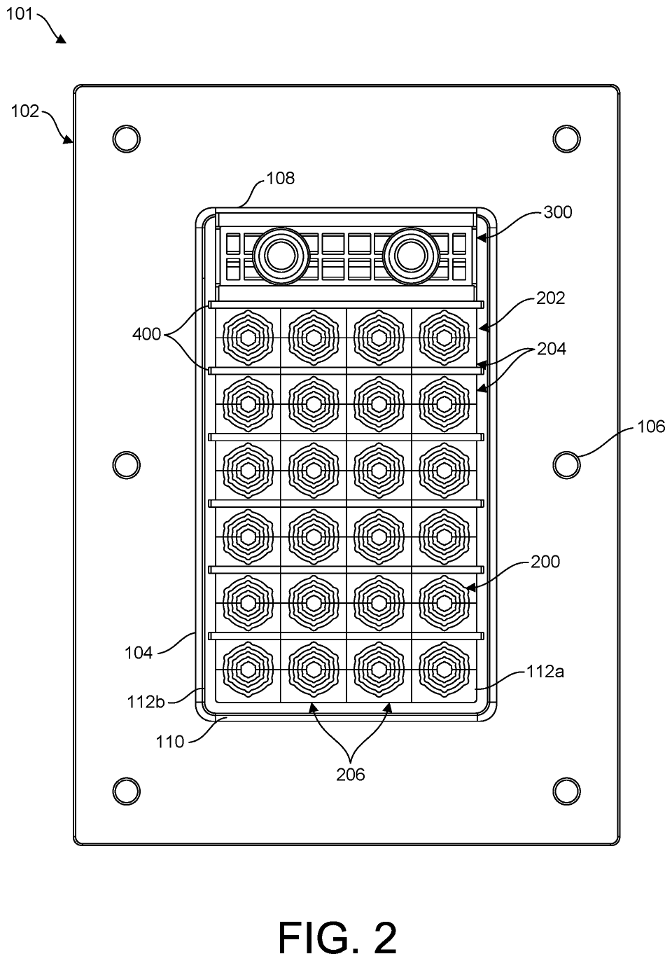

Referring to FIGS. 1-4, in an embodiment of the disclosure subject matter, a cable transit 100 may comprise a multi-cable transit 101 comprising a frame assembly 102, a plurality of modules 200 disposed within the frame assembly 102, and a compression wedge unit 300 positioned between the plurality of modules 200 and the frame assembly 102 assembly. Expansion of the compression wedge unit 300 results in compression of the plurality of modules 200 between the compression wedge unit 300 the frame assembly 102; thereby creating a gas-tight seal between the compression wedge unit 300, the plurality of modules 200, the frame assembly 102, and a cylindrical object disposed within one or more plurality of modules 200. The cylindrical object may include the core. An array 202 of the plurality of modules 200 comprises rows 204 and columns 206 of modules 200; wherein a stay plate 400 is demountably attached between each row 204 of the plurality of modules 200 in order to provide stability and restraint of the modules 200 within the frame assembly 102. Depending on the exterior dimensions of the modules 200 and the interior dimensions of the frame assembly 102, the array 202 may comprise different number combinations of rows 204 and columns 206 depending on the application.

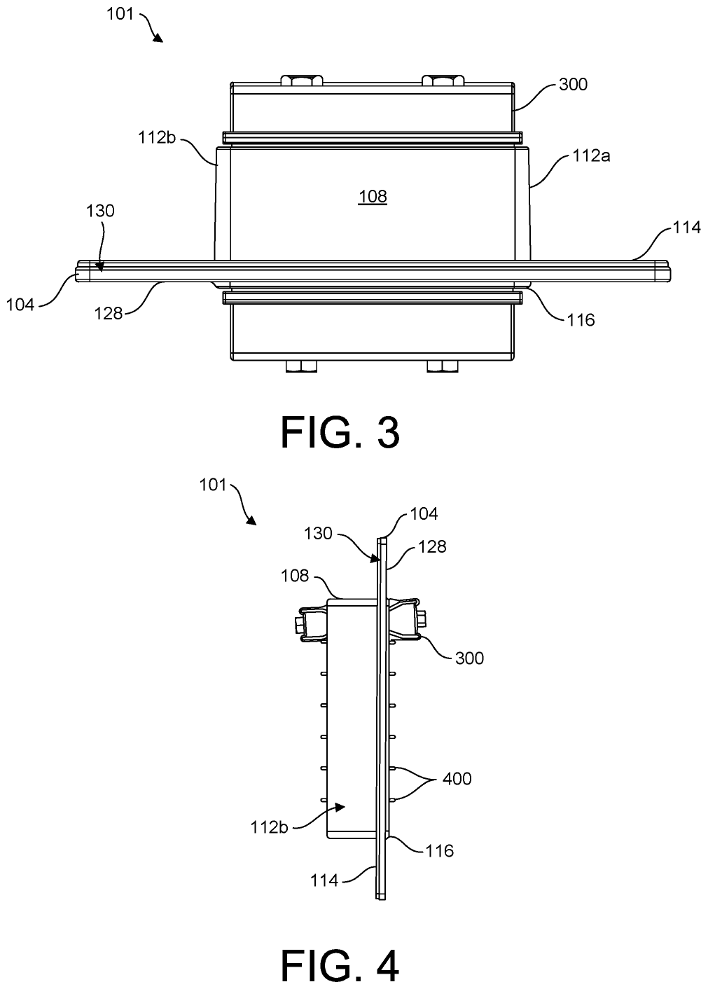

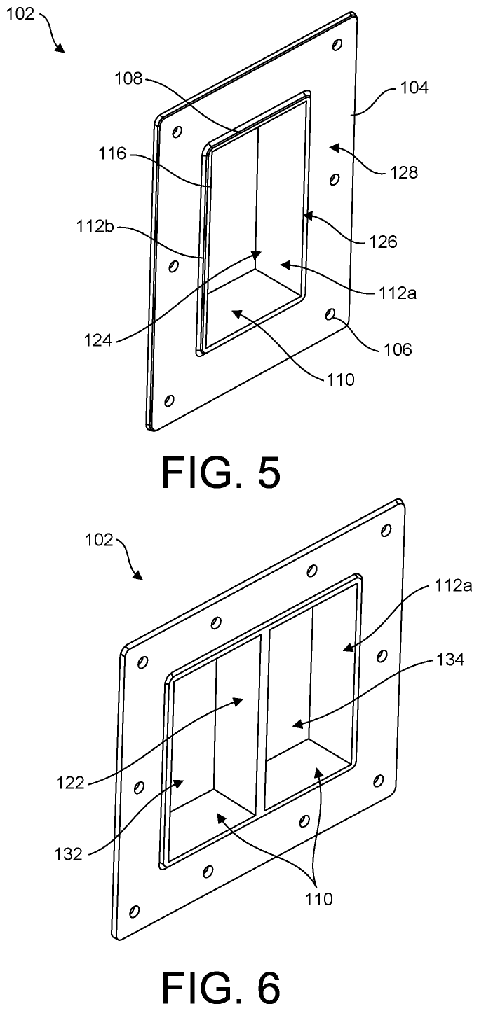

Referring to FIG. 5, the frame assembly 102 comprises: a top wall 108; a bottom wall 110; and two side walls 112a, 112b. The two side walls 112a, 112b are disposed generally perpendicular to the top wall 108 and the bottom wall 110; thereby creating a first window 124. The first window 124 having a peripheral edge 126. The frame assembly 102 further comprising a flange 104 connected to top, bottom, and two side walls (108, 110, 112a, and 112b) proximate the peripheral edge 126. The flange 104 perpendicularly extending outwardly and away from top, bottom, and two side walls (108, 110, 112a, and 112b). The flange 104 comprises a front surface 128 and rear surface 130 (see FIG. 3); wherein both the front surface 128 and the rear surface 130 are generally planar. The flange 104 comprises a plurality of holes 106 disposed through the front surface 128 and the rear surface 130. The flange 104 is configured to secure the frame assembly 102 to a mounting surface (not shown) using mechanical fasters such as, by way of example, bolts secured through the plurality of holes 106. In an embodiment of the disclosed subject matter, the top, bottom and two side walls (108, 110, 112a, and 112b) extend beyond the front surface 128 of the flange 104 forming a front peripheral edge 116. The flange 104, with or without use of a planar compression gasket 114, provides surface contact with a mounting surface, such as, by way of example, walls, decks, ceilings, floors, bulkheads, cabinets, etc.

The frame assembly 102 may be constructed of stiff, non-metallic materials that are UV resistant; hydrocarbon resistant; water resistant; meets 2 to 4 hour fire rating (including 2 hour jet fire); and is operable from −60 degrees Celsius to +80 degrees Celsius. The frame assembly 102 may be injection moldable and provide strong tensile strength. In a preferred embodiment, the frame assembly 102 has a 20 to 25-year ageing performance.

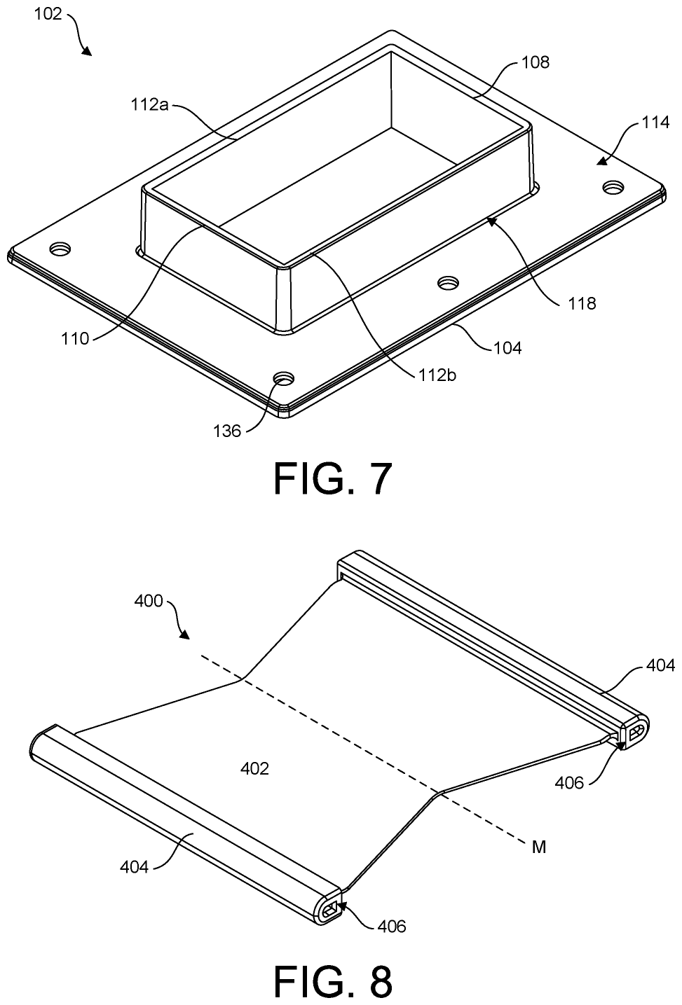

Referring to FIG. 6, in an embodiment of the disclosed subject matter, the frame assembly 102 comprises a central wall 122 attached between the top wall 108 and the bottom wall 110; the central wall 122 being perpendicular to the two side walls 112a, 112b. The central wall 122 forms a second window 132 and a third window 134, each having similar functionality as the first window 124 in FIG. 5.

Referring to FIG. 7, in an embodiment of the disclosed subject matter, the frame assembly 102 comprises a planar compression gasket 114 abutting the rear surface 130. The planar compression gasket 114 is configured to be compressed between the rear surface 130 and the mounting surface (not shown) by engagement of mechanical fasteners with the mounting surface; thereby creating a gas-tight and weather-tight seal between the mounting surface and rear surface 130. In other embodiments of the disclosed subject matter, the planar compression gasket 114 may be adhered to the rear surface 130. The planar compression gasket 114 comprises a central rectangular aperture 118 configured to abut the top wall 108, two side walls 112a, 112b, and bottom wall 110. In an embodiment of the disclosed subject matter, the planar compression gasket 114 further comprises a set of holes 136 aligned with the plurality of holes 106 of the flange 104. In other embodiments, the planar compression gasket 114 is extends between the central rectangular aperture 118 and the set of holes 136.

Referring to FIG. 8, in an embodiment of the disclosed subject matter, a stay plate 400 comprises: a central planar member 402 comprising a midline M; and two distal members 404 connected to opposite sides of the central planar member 402, the two distal members 404 being in parallel arrangement with each other. Each of the two distal members 404 comprising an inner surface 406 extending perpendicularly and away from the central planar member 402. The central planar member 402 tapers down from the two distal members 404 towards the midline M.

In an embodiment, the stay plate 400 is provided between each of the rows 204 to frictionally engage and prevent the modules 200 from lateral movement into or out of the frame assembly 102. The inner surface 406 of the two distal members 404 abut opposing edges of the two side walls 112a, 112b; thereby restraining the stay plate 400 from movement into (rearwardly) and out of (forwardly) the frame assembly 102. The inner surface 406 abut the front and back sides of the modules 200; thereby stabilizing and restraining the modules 200 during assembly of the MCT and compression of the modules 200 via the compression wedge unit 300.

The stay plate 400 is constructed of stiff materials that are UV resistant; hydrocarbon resistant; water resistant; rated for 2 to 4 hour fire resistance (including 2 hour jet fire); and is operable from −60 degrees Celsius to +80 degrees Celsius. The stay plate 400 may be injection moldable and provide strong tensile strength. In a preferred embodiment, the stay plate 400 has a 20 to 25-year ageing performance.

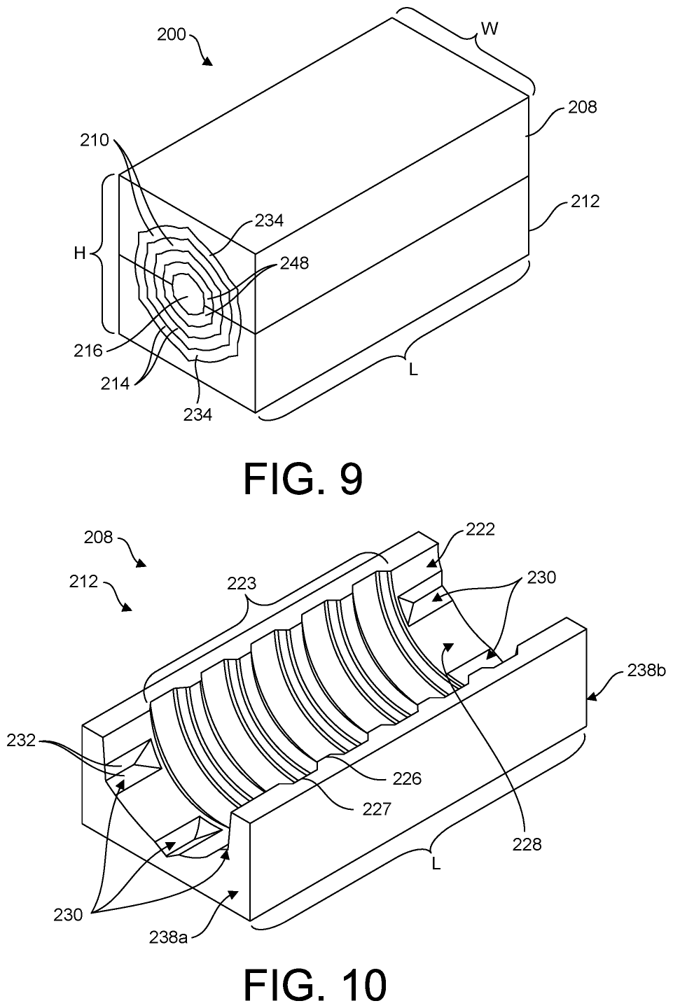

Referring to FIG. 9, in an embodiment of the disclosed subject matter, the module 200 comprises a height H, width W, and length L. In some embodiments, the height-width-length (H-W-L) combination of the module 200 comprises at least one of: 30 mm×30 mm×60 mm; 60 mm×60 mm×60 mm; 90 mm×90 mm×60 mm; 40 mm×40 mm×60 mm; or 20 mm×20 mm×60 mm. The module 200 comprises: an upper housing 208 configured to engage a plurality of upper layers 210; a lower housing 212 configured to engage a plurality of lower layers 214; and a core 216 disposed between the plurality of upper layers 210 and the plurality of lower layers 214. In an embodiment of the disclosed subject matter, the upper housing 208 and the lower housing 212 are interchangeable and symmetric to each other. When the core 216, or other cylindrical object, is installed between the plurality of upper layers 210 and the plurality of lower layers 214 and compressed, a gas-tight seal is provided across the module 200. Each of the plurality of upper layers 210 are configured to engage and interlock into adjacent upper layers, thereby creating resistance to axial and/or rotational forces. In a similar fashion, each of the plurality of lower layers 214 are configured to interlock into adjacent lower layers, thereby creating resistance to axial and rotational forces. The outermost layer 234 of each of the plurality of upper layers 210 and the plurality of lower layers 214 are configured to interlock into either of the the upper housing 208 or lower housing 212.

Referring to FIG. 10, in an embodiment of the disclosed subject matter, the upper housing 208 and the lower housing 212 each comprise a semi-circular channel 222 disposed along the length L of the upper housing 208 and the lower housing 212. When the upper housing 208 is aligned with and abuts the lower housing 212, a cylindrical aperture (not shown) is formed between the upper housing 208 and the lower housing 212. The semi-circular channel 222 comprises inner surface contours 223 in order to restrain the plurality of upper layers 210 and the plurality of lower layers 214 with the upper housing 208 and lower housing 212 respectively. In an embodiment of the disclosed subject matter, the inner surface contours 223 comprise a set of alternating side ribs 226 and side channels 227 radially disposed on an inner surface 228 of the semi-circular channel 222.

The inner surface contours 223 are configured to engage an exterior surface contours 236 of the outermost layer 234 (shown in FIGS. 9, 11 and 12) of the plurality of upper and lower layers 210, 214. The engagement of the inner surface contours 223 with the exterior surface contours 236 provides axial restraint between the upper housing 208 with the plurality of upper layers 210, and provides similar axial restraint between the lower housing 212 with the plurality of lower layers 214. The upper housing 208 and the lower housing 212 each further comprise a first set of notches 230 disposed proximate the distal ends of the semi-circular channel 222; each notch of the first set of notches 230 comprise two planar sidewalls 232 disposed at an obtuse angle to each other. The first set of notches 230 extend through the first outer surfaces 238a, 238b located at the distal ends of the upper housing 208 and lower housing 212. The first set of notches 230 provide rotational resistance between the upper housing 208 and the lower housing 212 with the outermost layer 234 of the plurality of upper layers 210 and the plurality of lower layers 214. The rotational resistance prevents the axil twisting of a cylindrical body disposed within the module 200.

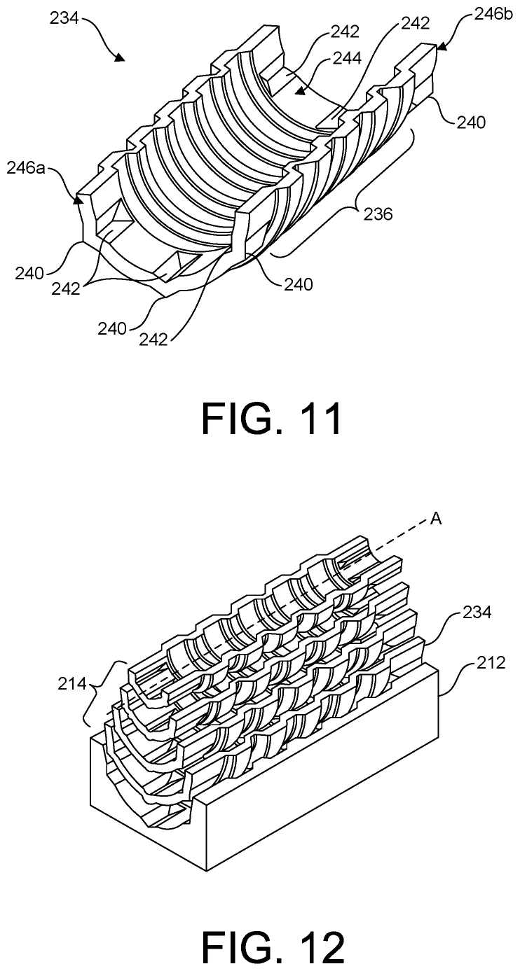

Referring to FIG. 11, in an embodiment of the disclosed subject matter, the outermost layer 234 of both the plurality of upper and lower layers 210, 214 is illustrated. The outermost layer 234 comprises exterior surface contours 236 which complement and interlock into the inner surface contours 223 so that the outermost layer 234 nests into the upper housing 208 and lower housing 212. The outermost layer 234 comprises a set of protrusions 240 configured to engage the set of notches 230 of the upper housing 208 and the lower housing 212. A second set of notches 242 are disposed proximate the distal ends of the interior surface 244 of the outermost layer 234; each notch of the second set of notches 242 comprise two planar sidewalls disposed at an obtuse angle to each other. The second set of notches 230 extend through the second outer surfaces (246a, 246b) located at the distal ends of outermost layer 234. The plurality of upper and lower layers (210, 214) comprise similar geometry as the outermost layer 234 but may comprise different radius of curvature.

Referring to FIG. 12, in an embodiment of the disclosed subject matter, an exploded view of the plurality of lower layers 214 is illustrated with the lower housing 212. Depending on the number of layers utilized, various sized cylindrical objects may be inserted along the central axis A of the module 200 when the plurality of lower layers 214 are assembled. The plurality of upper layers 210 and the upper housing 208 comprise similar geometry as the plurality of lower layers 214 and the lower housing 212 respectively, and function in a similar manner.

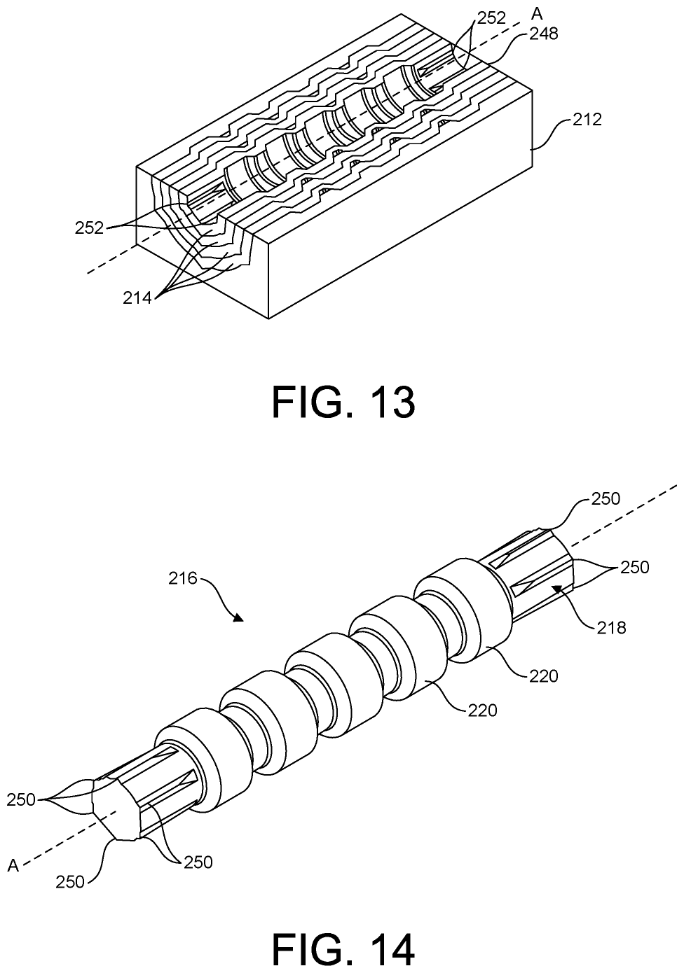

Referring to FIG. 13, in an embodiment of the disclosed subject matter, an assembled view of the plurality of lower layers 214 is illustrated with the lower housing 212. In a similar fashion, the plurality of upper layers 210 may be assembled with the upper housing 208.

Referring to FIG. 14, in an embodiment of the disclosed subject matter, a core 216 is provided for each module 200 to provide a gas-tight seal between two sides of the modules when a cylindrical object is not provided along the axis A of the module 200. The core 216 allows for effective cable/pipe management since the module 200 may be sealed without the use of a cylindrical object. The cores 216 additionally provide for future capacity of the multi-cable transit 101 without redesign of the frame assembly 102. The core 216 is configured to engage the innermost layers 248 of the upper housing 208 and the lower housing 212. The core 216 comprises a central cylinder 218 having a plurality of ribs 220 disposed along the exterior surface of the central cylinder 218. The plurality of ribs 220 are separated an equal distance along the central cylinder 218. The plurality of ribs 220 are configured to seat and interlock into the side channels 227 of the innermost layers 248 of the upper housing 208 and the lower housing 212. The core 216 comprises a set of surface protrusions 250 proximate each distal end of the central cylinder 218. The set of surface protrusions 250 are evenly spaced around the circumference of the central cylinder 218, the set of surface protrusions 250 are configured to engage a third set of notches 252 on the innermost layer 248 (shown on FIG. 13). In an embodiment of the disclosed subject matter, the set of surface protrusions 250 comprise three planar sides forming an obtuse angle at the two distal ends of the core 216.

In an embodiment of the disclosed subject matter, the plurality of modules 200 may be constructed of flexible, tear-resistant, highly elastic material with a minimum resistance for compression. In addition, the plurality of modules 200 may be UV resistant; hydrocarbon resistant; water resistant; rated for 2 to 4 hour fire resistance (including 2 hour jet fire); operable from −60 degrees Celsius to +80 degrees Celsius; exhibit anti-cold properties; and include a 20 to 25-year ageing performance.

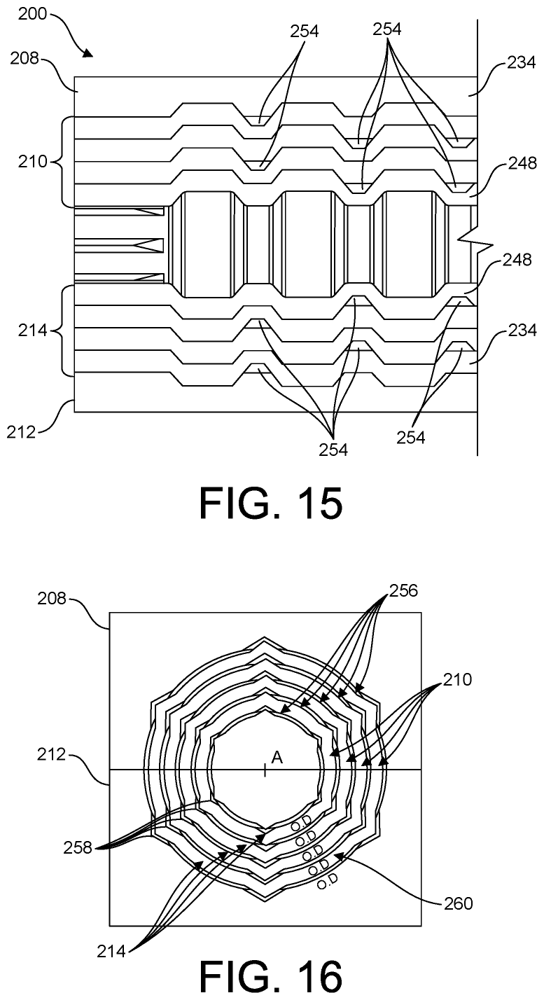

Referring to FIG. 15, in an embodiment of the disclosed subject matter, a plurality of air gaps 254 are formed between the plurality of upper layers 210 and the plurality of lower layers 214. The plurality of air gaps 254 are also formed between the outermost layer 234 and the upper housing 208 and lower housing 212. The plurality of air gaps 254 provide space for the plurality of upper and lower layers (210, 214) and the upper and lower housings (208, 212) to deform into when the module 200 is compressed by the compression wedge unit 300. Additionally, the plurality of air gaps 254 assist in sealing between the layers and housing to prevent ingress of water, gas and/or dust into the modules 200.

FIG. 16 illustrates a front view of the upper housing 208, the plurality of upper layers 210, the lower housing 212, and the plurality of lower layers 214. The physical interface of the upper housing 208, the plurality of upper layers 210, the lower housing 212, and the plurality of lower layers 214, creates a set of concentric rings 256 having a set of interlocking points 258, disposed equidistant around the set of concentric rings 256, upon the front and rear surfaces of the module 200. In an embodiment, the set of interlocking points 258 comprise six interlocking points equally disposed 60 degrees about the central axis A.

In an embodiment, the upper housing 208, the lower housing 212, the plurality of upper and lower layers (210, 214), and core 216 may comprise distinct and/or alternating color schemes (such as orange and black) in order to provide visual indication of the housings (208, 212), plurality of upper and lower layers (210, 214), and core 216. The distinct color schemes may correlate with a range of working cable/pipe diameters associated with the specific layers or housings. In another embodiment, an identifier 260 may be affixed, embossed, and/or embedded to at least one of the plurality of upper layers 210, the plurality of lower layers 214, the upper housing 208, and/or the lower housing 212 in order to identify a range of working cable/pipe diameters associated with one or more layers and/or housings.

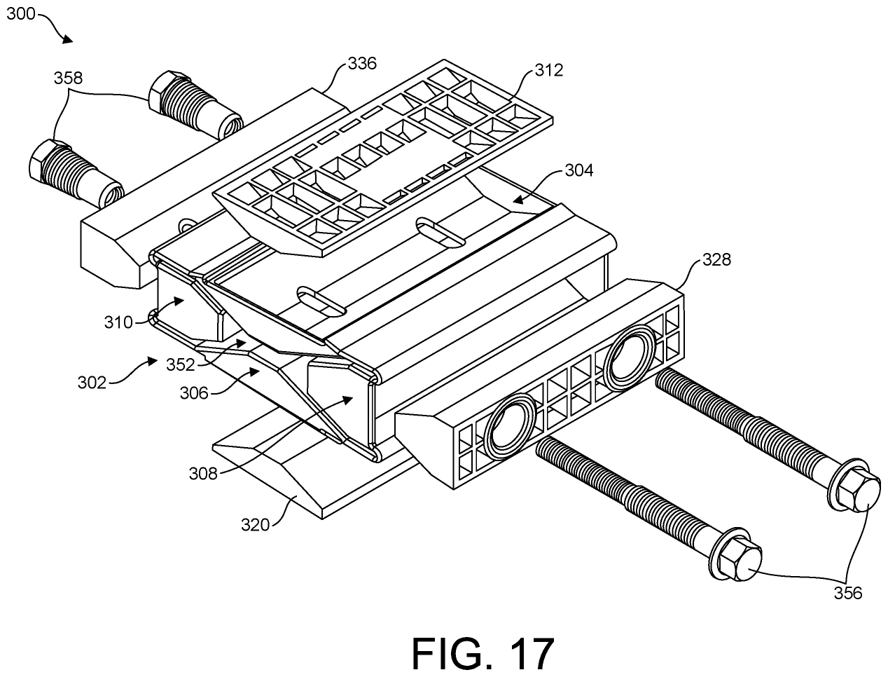

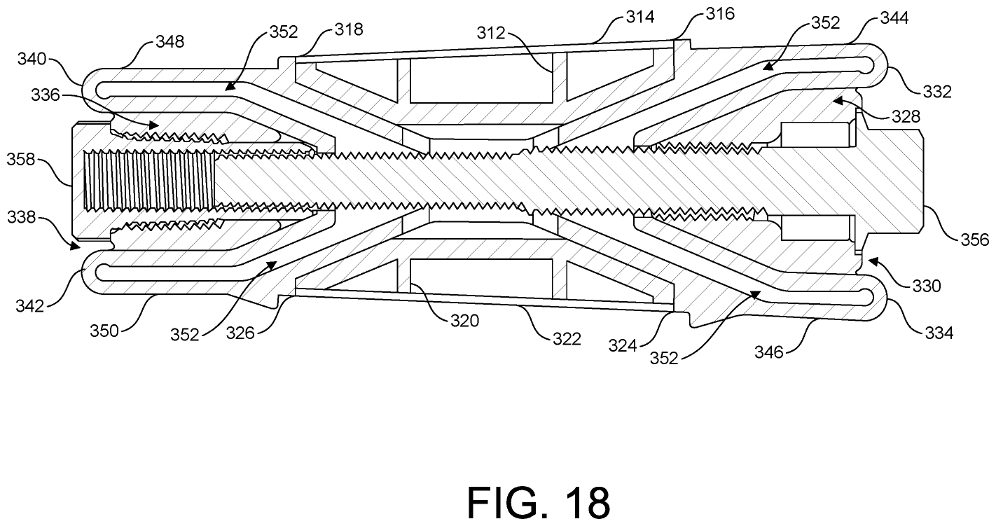

Referring to FIG. 17-18, in an embodiment of the disclosed subject matter, the compression wedge unit 300 may vertically expand up to about 20 mm; thereby compressing the plurality of the modules 200 within the frame assembly 102 (as shown in FIG. 1).

The compression wedge unit 300 comprises a central receiving module 302 comprising a top receiver 304; a bottom receiver 306 disposed opposite the top receiver 304; a front receiver 308 partially disposed between the top receiver 304 and the bottom receiver 306; and a back receiver 310 disposed opposite the front receiver 308, the back receiver 310 partially disposed between the top receiver 304 and the bottom receiver 306. The top receiver 304 is configured to receive and retain a top wedge insert 312. The top wedge insert 312 may be recessed about 2.5 mm from a top opening 314 of the top receiver 304. The top opening 314 comprises a top-front peripheral edge 316 and a top-back peripheral edge 318 spanning a width of the central receiving module 302. The bottom receiver 306 is configured to receive and retain a bottom wedge insert 320. The bottom wedge insert 320 is recessed about 2.5 mm from a bottom opening 322 of the bottom receiver 306. The bottom opening 322 comprises a bottom-front peripheral edge 324 and a bottom-back peripheral edge 326 spanning a width of the central receiving module 302. The front receiver 308 is configured to receive and retain a front wedge insert 328. The front wedge insert 328 is recessed about 2.5 mm from a front opening 330 of the front receiver 308. The front opening 330 comprises a front-top peripheral edge 332 and a front-bottom peripheral edge 334 spanning a width of the central receiving module 302. The back receiver 310 is configured to receive and retain a back wedge insert 336. The back wedge insert 336 is recessed about 2.5 mm from a back opening 338 of the back receiver 310. The back opening 338 comprises a back-top peripheral edge 340 and a back-bottom peripheral edge 342 spanning a width of the central receiving module 302.

The central receiving module 302 further comprises: a first retaining member 344 connected between the top-front peripheral edge 316 and the front-top peripheral edge 332; a second retaining member 346 connected between the bottom-front peripheral edge 324 and the front-bottom peripheral edge 334; a third retaining member 348 connected between top-back peripheral edge 318 and the back-top peripheral edge 340; and a fourth retaining member 350 connected between the bottom-back peripheral edge 326 and the back-bottom peripheral edge 342. The central receiving module 302 is constructed of polymers and may be injection molded.

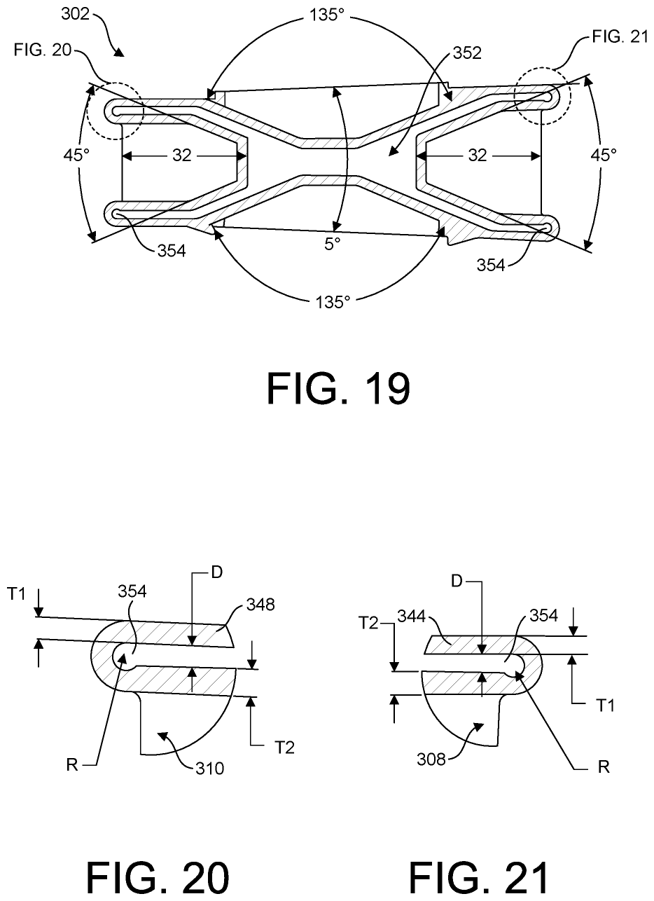

The compression wedge unit 300 further comprises a set of dual-threaded bolts 356 and a corresponding set of nuts 358 to secure the front wedge insert 328 and the back wedge insert 336 to each other and compress the central receiving module 302 from front to back; thereby rotating the first and second retaining members (344, 346) upwardly about the relief points 354 (shown in FIG. 19), rotating the third and fourth retaining members (348, 350) downwardly about the relief points 354, and expanding the distance between the top wedge insert 312 and bottom wedge insert 320. When each bolt of the set of dual-threaded bolts 356 are turned clockwise, the engagement with the nuts 358 simultaneous pulls the front wedge insert 328 and back wedge insert 336 towards the center of the central receiving module 302; resulting in vertical expansion of the compression wedge unit 300; thereby delivering compression to the surrounding components of the multi-cable transit 101 to provide a gas-tight, water-tight security for the multi-cable transit 101. The set of dual-threaded bolts 356 and the set of nuts 358 may be constructed of stainless steel, such as 316L SS, or equivalent.

Referring to FIGS. 19-21, a void 352 is formed between each of the top, bottom, front and back receivers (304, 306, 308, 310). Additionally, an offset distance D is formed between retaining members (344, 346, 348, 350) and adjacent receivers (304, 306, 308, 310). In an embodiment, the offset distance D is about 2 mm. Each of the retaining members (344, 346, 348, 350) comprise a relief point 354 formed by a 90-degree bend along the width of the retaining members (344, 346, 348, 350) proximate the front and back receivers (308, 310). In some embodiments, a radius R of the 90-degree bend is about 1.25 mm. The relief points 354 allow the central receiving module 302 to fully contract and compress without excessive resistance. In some embodiments, the retaining members (344, 346, 348, 350) comprise a first thickness T1 of about 2 mm. In other embodiments, front and back receivers (308, 310) comprise a second thickness T2 of about 2.5 mm proximate retaining members (344, 346, 348, 350). The central receiving module 302 is tapered about 5 degrees from front to back to assist in the insertion of the compression wedge unit 300 into the frame assembly 102.

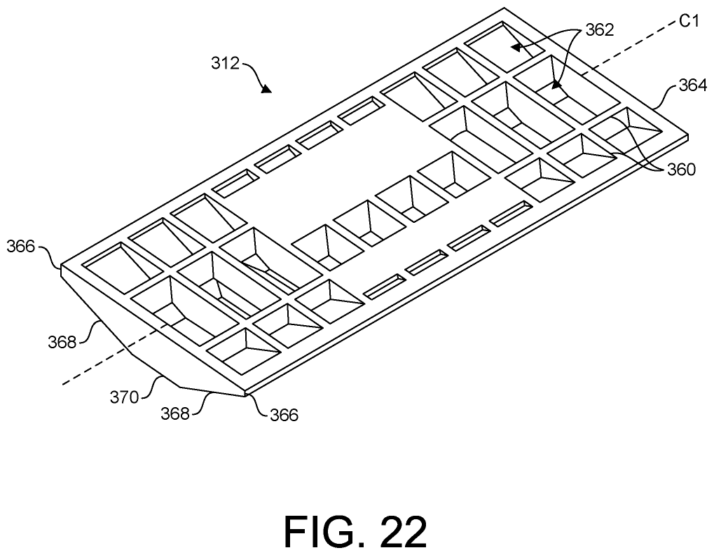

Referring to FIG. 22, in an embodiment of the disclosed subject matter, the top wedge insert 312 comprises a first plurality of perpendicular ribs 360 forming a first plurality of voids 362 disposed between the first plurality of perpendicular ribs 360. The top wedge insert 312 further comprises a first rectangular top portion 364 bounded by the first plurality of perpendicular ribs 360. The first rectangular top portion 364 configured to contact the top wall 108 of the frame assembly 102. The top wedge insert 312 comprises two first vertical sidewalls 366 that extend downwardly from the first rectangular top portion 364. A pair of first tapered sidewalls 368, connected to the two first vertical sidewalls 366, taper downwardly toward a first central line C1 of the top wedge insert 312. The pair of first tapered sidewalls 368 are connected to a first flat bottom section 370; the first flat bottom section 370 section is generally parallel with the first rectangular top portion 364. The pair of first tapered sidewalls 368 are configured to abut the top receiver 304.

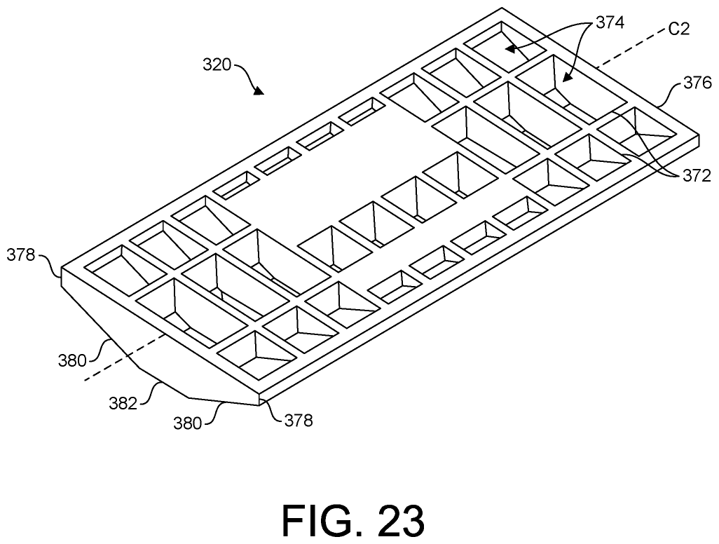

Referring to FIG. 23, in an embodiment of the disclosed subject matter, the bottom wedge insert 320 comprises a second plurality of perpendicular ribs 372 forming a second plurality of voids 374 disposed between the second plurality of perpendicular ribs 372. The bottom wedge insert 320 further comprises a second rectangular top portion 376 bounded by the second plurality of perpendicular ribs 372. The second rectangular top portion 376 configured to contact the stay plate 400. The bottom wedge insert 320 comprises two second vertical sidewalls 378 that extend downwardly from the second rectangular top portion 376. A pair of second tapered sidewalls 380, connected to the two second vertical sidewalls 378, taper downwardly toward a second central line C2 of the bottom wedge insert 320. The pair of second tapered sidewalls 380 are connected to a second flat bottom section 382; the second flat bottom section 382 section is generally parallel with the second rectangular top portion 376. The pair of second tapered sidewalls 380 are configured to abut the bottom receiver 306.

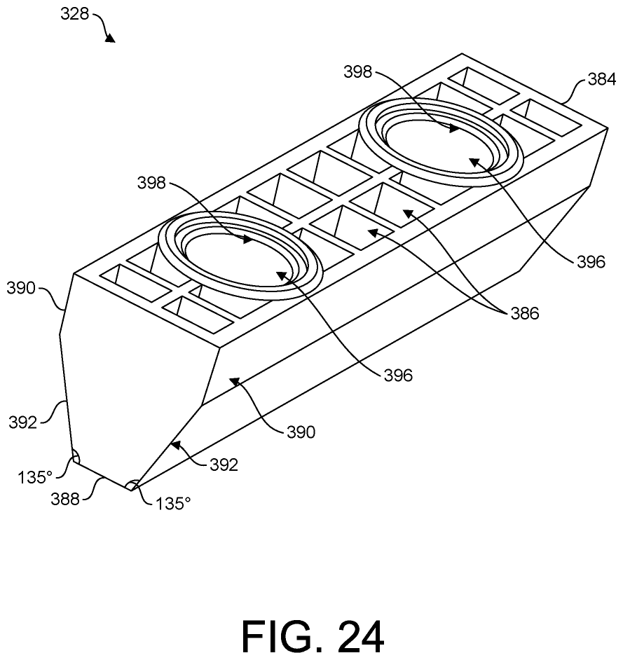

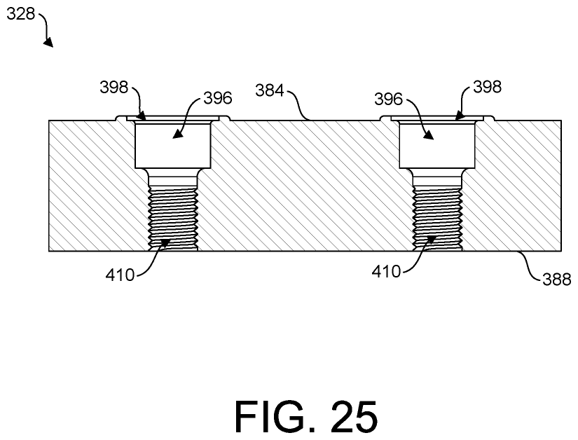

Referring to FIGS. 24-25, in an embodiment of the disclosed subject matter, the front wedge insert 328 comprises: a first front surface 384 having a plurality of front voids 386 partially disposed through the front wedge insert 328; a first back surface 388 being generally parallel to the first front surface 384; a pair of third vertical sidewalls 390 extending parallel from the first front surface 384; and a pair of third tapered sidewalls 392 connected between the pair of third vertical sidewalls 390 and first back surface 388. The pair of third tapered sidewalls 392 are each inclined about 135 degrees with the first back surface 388. The front wedge insert 328 further comprises a set of front bolt holes 396 extending through the first front surface 384 and the first back surface 388; each of the set of front bolt holes 396 comprises an inset ledge 398 disposed proximate the first front surface 384, and a first set of threads 410 partially disposed upon the interior of the front bolt holes 396.

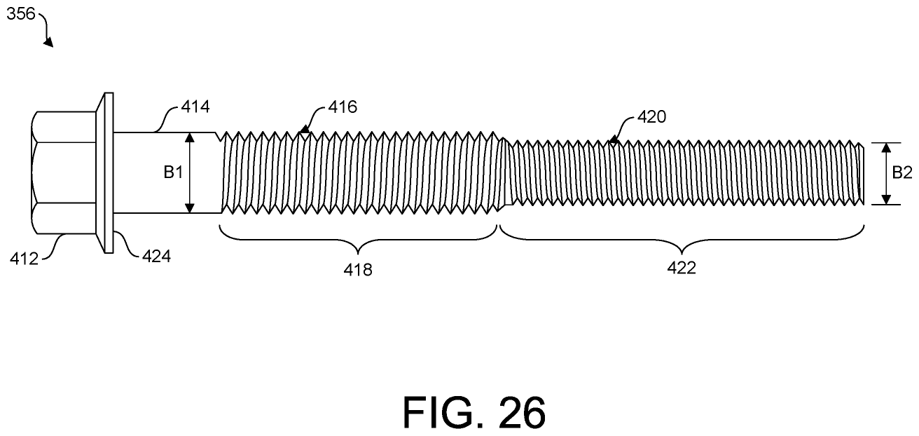

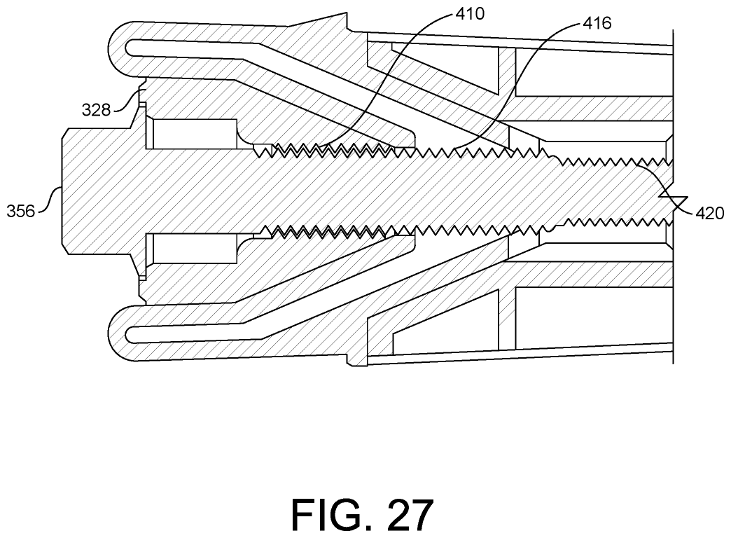

Referring to FIGS. 26-27, in an embodiment of the disclosed subject matter, one bolt of the set of dual-threaded bolts 356 is illustrated. Each bolt of the set of dual-threaded bolts 356 comprises a bolt head 412; a shank 414; a second set of threads 416 having a second thread pattern 418; and a third set of threads 420 having a third thread pattern 422. The shank 414 and second set of threads 416 having a diameter of B1; the third set of threads 420 having a diameter of B2; wherein B1 is greater than B2. The second thread pattern 418 configured to mate with the first set of threads 410 on the front wedge insert 328; the second thread pattern 418 is reversed threaded from the third thread pattern 422. The second thread pattern 418 may comprise a 10 mm×1.5 thread pitch. The third thread pattern may comprise an 8 mm×1.25 thread pitch. A bolt flange 424 connected between the bolt head 412 and shank 414 is configured to engage the inset ledge 398 of the front wedge insert 328 creating a full mechanical stop and preventing the unthreading of the set of nuts 358.

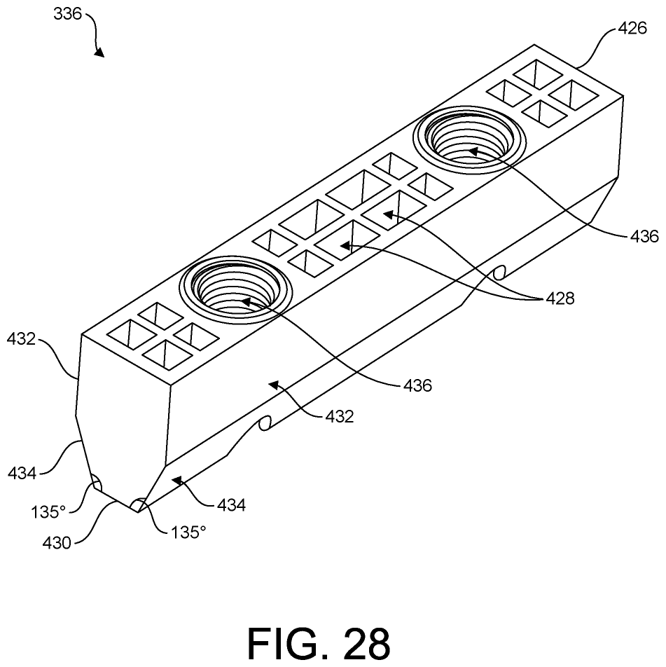

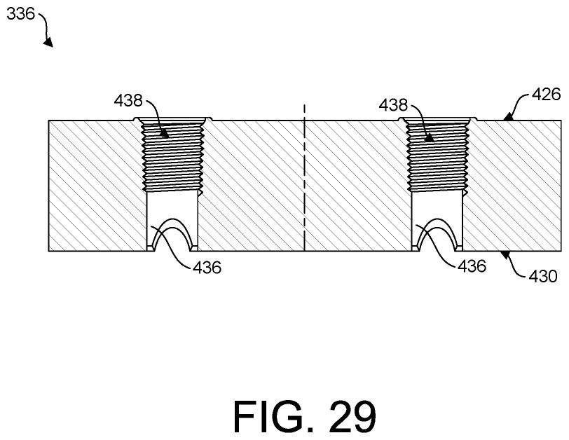

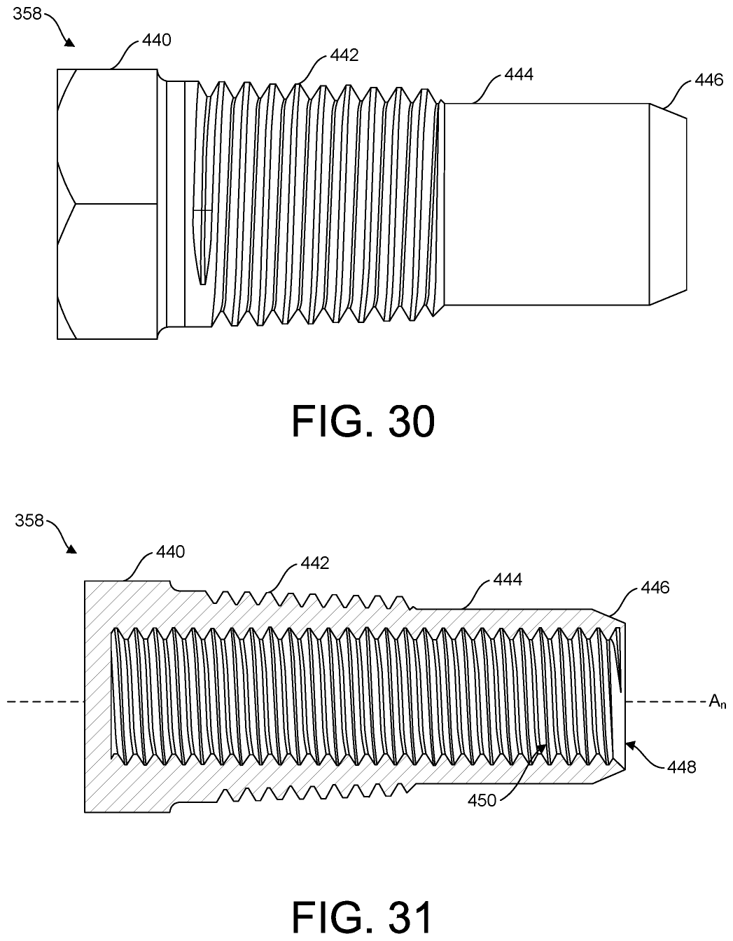

Referring to FIGS. 28-29, in an embodiment of the disclosed subject matter, the back wedge insert 336 comprises: a second back surface 426 having a plurality of back voids 428 partially disposed through the back wedge insert 336; a second front surface 430 being generally parallel to the second back surface 426; a pair of fourth vertical sidewalls 432 extending parallel from the second back surface 426; and a pair of fourth tapered sidewalls 434 connected between the fourth vertical sidewalls 432 and second front surface 430. The pair of fourth tapered sidewalls 434 are each included about 135 degrees with the second front surface 430. The back wedge insert 336 further comprises a set of back bolt holes 436 extending through the second back surface 426 and second front surface 430; each of the set of back bolt holes 436 comprises a fourth set of threads 438 interiorly disposed partially within the back bolt holes 436 and proximate to the second back surface 426. The fourth set of threads 438 may comprise a 1.25″ NPT nut thread (internal).

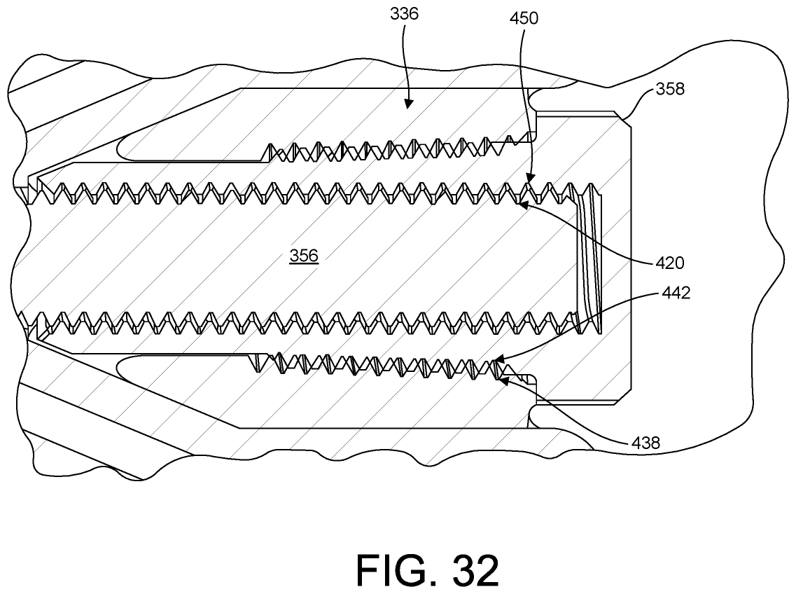

Referring to FIGS. 30-32, in an embodiment of the disclosed subject matter, one of nuts of the set of nuts 358 is illustrated. Each nut of set of nuts 358 comprises: a nut head 440; a fifth set of threads disposed proximate the nut head 440; a nut shank 444; a tapered section 446; a bore hole 448 proximate the tapered section 446 and interiorly disposed along an axis Aₙ of the nut 358. The bore hole 448 extending through the tapered section 446, but not extending completely through the nut head 440. A sixth set of threads 450 interiorly disposed around the circumference of the bore hole 448. The fifth set of threads 442 are configured to mate with the fourth set of threads 438 of the back wedge insert. The fifth set of threads 442 may comprise a 1.25″ NPT thread (external). The sixth set of threads 450 are configured to mate with the third set of threads 420 of the set of dual-threaded bolt 356. In an embodiment, the sixth set of threads 450 may comprise an 8 mm×1.25 thread (internal).

The multi-cable transit 101 may sealed to a barrier by installing the frame assembly and gasket against a surface having an opening large enough to accommodate the top, bottom, and two side walls of the frame assembly, thereby creating a window between the two sides of the barrier. Means of mounting the frame assembly to a barrier may include use of bolts, nails, screws, welds, adhesives, cast into concrete structures, or other known means of attachment.

The multi-cable transit 101 provides a gas-tight seal between two sides of a barrier by utilizing a core within each of the plurality of modules. Any number of the cores may be removed and a generally cylindrical object, such as a cable, conduit or pipe, may be installed within the module to provide a gas-tight seal around the cylindrical object. Depending on the diameter of the cylindrical object, none, or one or more of the plurality of upper layers or the plurality of lower layers may be removed prior to installation of the cylindrical object to accommodate a diameter of the cylindrical object. A cylindrical object may be sealed and restrained within a module by expanding the compression wedge unit against the frame assembly. The expansion of the compression unit compresses the modules about the cores, or cylindrical objects, disposed within the modules, creating a gas-tight seal around the cores or cylindrical objects. As the side ribs and side channels of the housing and/or layers are compressed around the cores and/or cylindrical objects, a gas-tight seal is formed around the cores and/or cylindrical objects. The cylindrical objects are restrained from axial (front to back) forces by engagement of the side ribs and side channels within the modules. In addition, the cylindrical objects are restrained from rotation forces by engagement of the set of protrusions within the set notches disposed around the plurality of upper layers, the plurality of lower layers, and the housings of the modules.

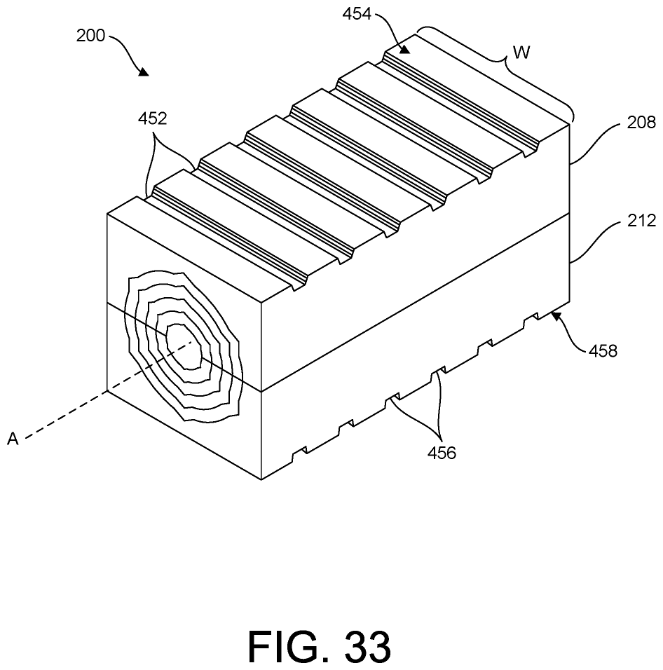

Referring to FIG. 33, in an embodiment of the disclosed subject matter, a plurality of upper channels 452 may extend along the width W of an upper module surface 454 of the upper housing 208. In a similar manner, a plurality of lower channels 456 may extend along the width W of a lower module surface 458 of the lower housing 212. The plurality of upper channels 452 and the plurality of lower channels are generally aligned perpendicular to central axis A of the module 200.

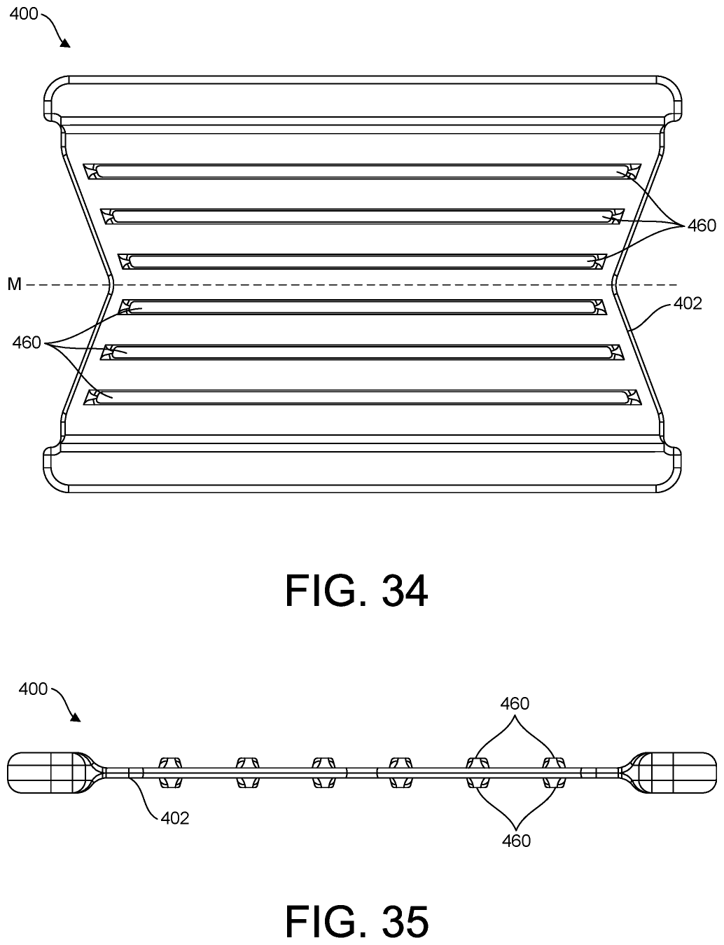

Referring to FIGS. 34-35, in an embodiment of the disclosed subject matter, the stay plate 400 may comprise a plurality of ridges 460 extending in opposite directions from the central planar member 402. The plurality of ridges 460 may be in parallel arrangement with the midline M of the stay plate 400. The plurality of ridges 460 may tapered to frictionally engage the plurality of upper channels 452 and the plurality of lower channels 456 of the plurality of modules 200 (shown in FIG. 33) to assist in the restraint of movement of the plurality of modules 200 withing the frame assembly 102.

Single Cable Transit

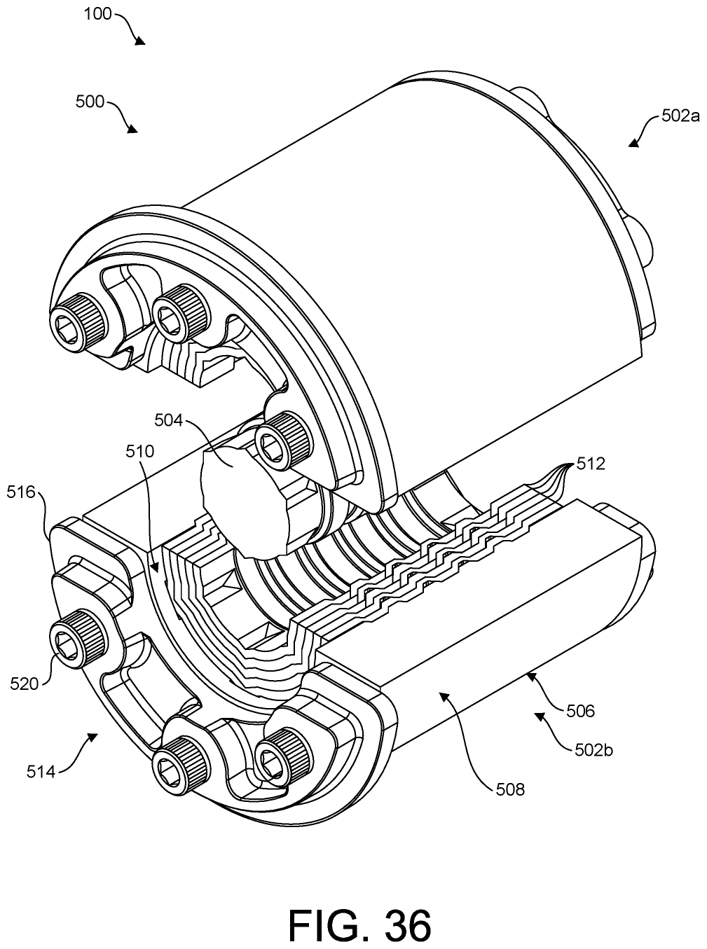

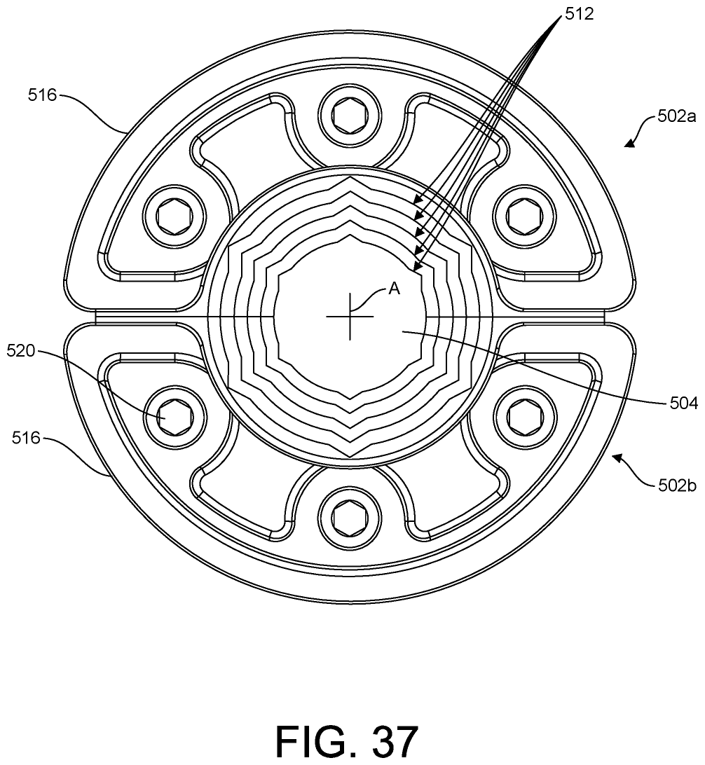

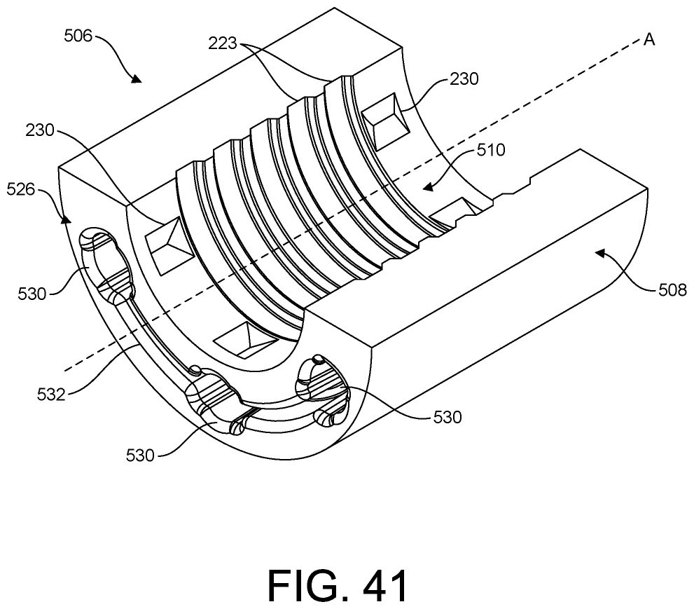

Referring to FIGS. 36-38, in an embodiment of the disclosed subject matter, the cable transit 100 may comprise a single cable transit 500 having a pair of component halves 502a,b to secure a central core 504 or cylindrical body (not shown) along the central axis of the pair of component halves 502a,b. Each of the pair of component halves 502a,b may comprise: an u-shaped body 506 having a curved outer surface 508 and a contoured inner surface 510 (shown in FIG. 41); a plurality of interlocking layers 512a-e connected to the u-shaped body 506 along the contoured inner surface 510; and a compression member 514 configured to axially compress the u-shaped body 506;

whereby axial compression of the u-shaped body urges the curved outer surface 508 away from the central axis A and urges the contoured inner surface 510 towards the central axis A, thereby compressing and restraining a central core 504 or cylindrical body (not shown) between the u-shaped body and providing a gas-tight seal between the single cable transit 500 and a structural opening (not shown).

The compression member 514 may comprise a pair of front plates 516 connected to a pair of back plates 518 by means of a plurality of bolts 520 treaded into the pair of back plates 518. The pair of front plates 516 may comprise a plurality of bolt holes 522 configured to receive the receive and secure the plurality of bolts 520. The pair of back plates 518 may comprise a plurality of internally threaded holes 524 to mate with the plurality of bolts 520.

The plurality of interlocking layers 512a-e comprise similar features as the plurality of upper layers 210 and the plurality of lower layers 214 (shown in FIGS. 12-13 and 15-16). The plurality of interlocking layers 512a-e provide axial and rotational restraint of the central core 504 or a cylindrical body (not shown) disposed along the central axis A.

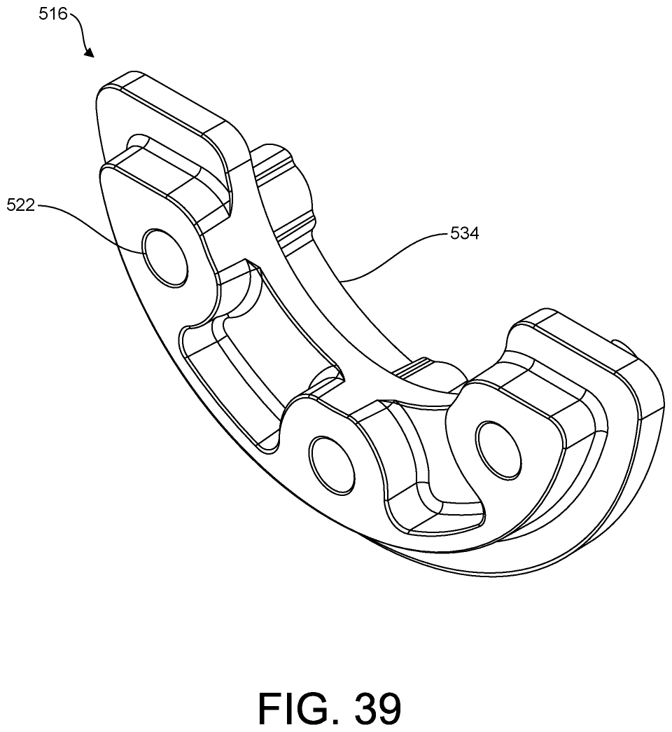

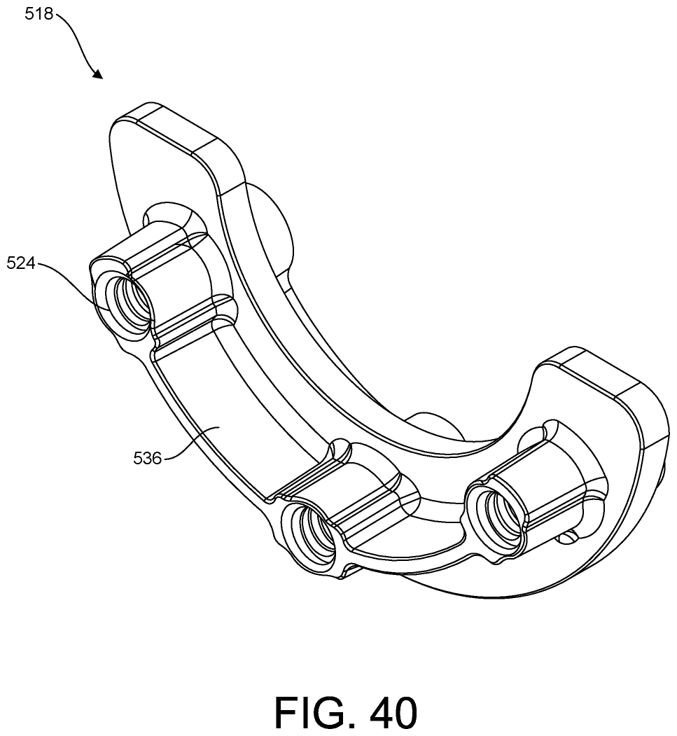

Referring to FIGS. 39 and 40, in an embodiment of the disclosed subject matter, the pair of front plates 516 and the pair of back plates 518 are generally u-shaped to accommodate a cylindrical object secured between the u-shaped body 506 along the central axis A. The plurality of bolts 520 may be evenly spaced around the central axis A to create uniform axial compression of the u-shaped body 506 when the plurality of bolts 520 are threaded into the plurality of internally threaded holes 524. The pair of front plates 516 may include a first curved projection 534 extending rearwardly from the each of the pair of front plates 516. The first curved projection 534 connected between the plurality of bolt holes 522. The pair of back plates 518 may include a second curved projection 536 extending forwardly from the each of the pair of back plates 518. The second curved projection 536 connected between the plurality of internally threaded holes 524.

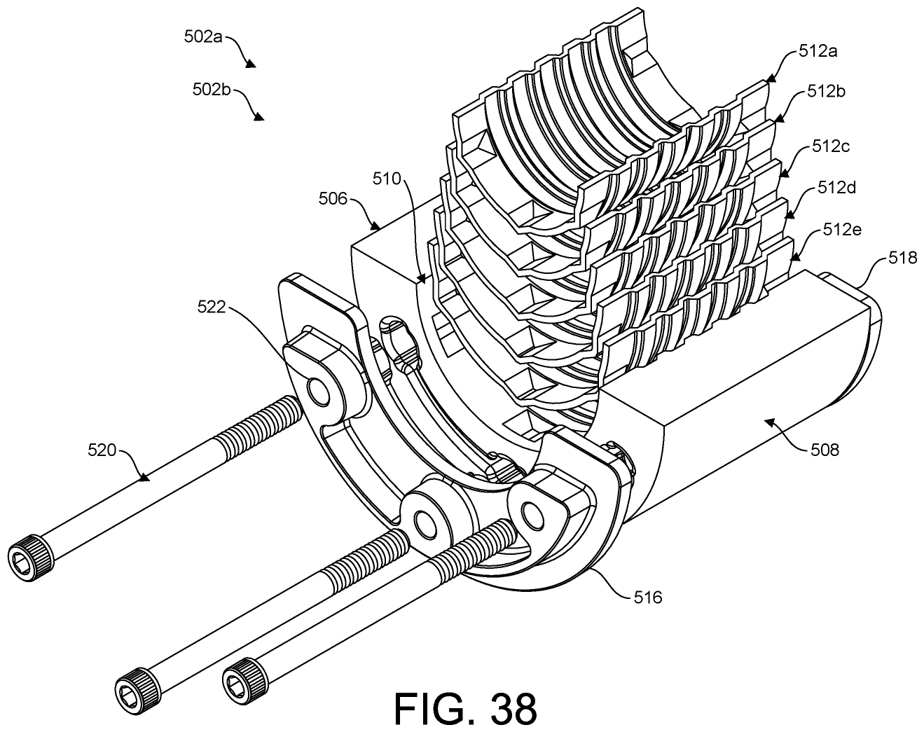

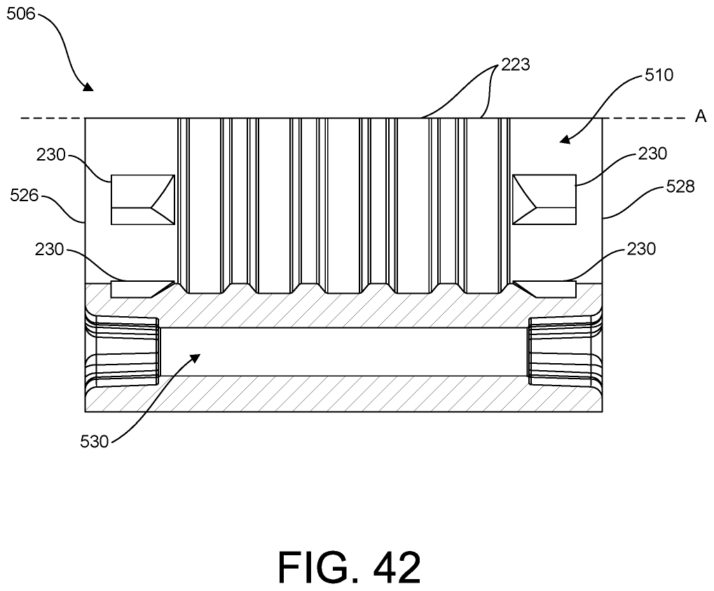

Referring to FIGS. 41 and 42, in an embodiment of the disclosed subject matter, the u-shaped body 506 comprises inner surface contours 223 and first set of notches 230 to interlock with the plurality of interlocking layers 512a-e. The u-shaped body 506 includes a front surface 526 and a back surface 528 opposite the front surface 526, wherein a plurality of holes 530 are formed through the u-shaped body 506 between the front surface 526 and the back surface 528. The plurality of holes 530 are sized to receive the plurality of bolts 520 (shown in FIG. 38). A front curved channel 532 may extend along the front surface 526 and between the plurality of holes 530. A back curved channel (not shown) may extend along the back surface 528 and between the plurality of holes 530.

In an embodiment, the first curved projection 534 is seated into the front curved channel 532 in order to secure and restrain the pair of front plates 516 with the u-shaped body 506. In a similar manner, the second curved projection 536 is seated into the rear curved channel (not shown) in order to secure and restrain the pair of back plates 518 with the u-shaped body 506.

It is to be understood that while certain embodiments and aspects of the disclosed subject matter have been shown and described, the disclosed subject matter is not limited thereto and encompasses various other embodiments and aspects.

Insofar as the description above and the accompanying drawings disclose any additional subject matter that is not within the scope of the single claim below, the inventions are not dedicated to the public and the right to file one or more applications to claim such additional inventions is reserved.

1. A multi-cable transit comprising:
a frame assembly;
a plurality of modules disposed within the frame assembly; each of the plurality of modules comprising:
an upper housing;
a lower housing disposed opposite the upper housing; and
a plurality of upper layers and a plurality of lower layers disposed between the upper housing and the lower housing; and
a compression wedge unit connected between the frame assembly and the plurality of modules,
wherein expansion of the compression wedge unit compresses the plurality of modules within the frame assembly to form a gas-tight seal within the plurality of modules.

2. The multi-cable transit of claim 1, wherein each of the plurality of upper layers and the plurality of lower layers comprising alternating side ribs and side channels configured to restrain axial movement of the plurality of upper layers and the plurality of lower layers.

3. The multi-cable transit of claim 2, further comprising a plurality of air gaps formed between the plurality of upper layers, the plurality of lower layers, the upper housing, and the lower housing.

4. The multi-cable transit of claim 1, wherein the plurality of upper layers and the plurality of lower layers comprising a set of protrusions configured to restrain rotational movement of the plurality of upper layers and the plurality of lower layers.

5. The multi-cable transit of claim 1, wherein the upper housing comprises a plurality of upper channels, and wherein the lower housing comprises a plurality of lower channels.

6. The multi-cable transit of claim 1, wherein the plurality of modules comprising a core connected between the plurality of upper layers and the plurality of lower layers.

7. The multi-cable transit of claim 6, wherein the core comprises:
a central cylinder having an exterior surface; and
a plurality of ribs disposed along the exterior surface.

8. The multi-cable transit of claim 1, further comprising a stay plate demountably attached between the plurality of modules.

9. The multi-cable transit of claim 8, wherein the stay plate comprises a central planar member having a plurality of ridges extending in opposite directions from the central planar member.

10. The multi-cable transit of claim 1, wherein the compression wedge unit comprises:
a central receiving module comprising:
a top receiver configured to receive and retain a top wedge insert;
a bottom receiver configured to receive and retain a bottom wedge insert, the bottom receiver disposed opposite the top receiver;
a front receiver configured to receive and retain a front wedge insert, the front receiver partially disposed between the top receiver and the bottom receiver; and
a back receiver configured to receive and retain a back wedge insert, the back receiver disposed opposite the front receiver, the back receiver partially disposed between the top receiver and the bottom receiver;
a set of dual-threaded bolts configured to engage the front wedge insert; and
a set of nuts configured to engage the back wedge insert and the set of dual-threaded bolts,
wherein rotation of the set of dual-threaded bolts urges the front receiver and the back receiver towards each other, thereby expanding the compression wedge unit which compresses the plurality of modules within the frame assembly to form a gas-tight seal within the plurality of modules.

11. A single cable transit comprising:
a pair of component halves having a central axis, each of the pair of component halves comprising:
a u-shaped body having a curved outer surface and contoured inner surface; and
a compression member configured to axially compress the u-shaped body,
whereby axial compression of the u-shaped body urges the curved outer surface away from the central axis and urges the contoured inner surface towards the central axis, thereby providing a gas-tight seal between the pair of component halves.

12. The single cable transit of claim 11, further comprising a plurality of interlocking layers connected to the u-shaped body along the contoured inner surface.

13. The single cable transit of claim 12, wherein the contoured inner surface comprises an inner surface contours and a first set of notches configured to interlock with the plurality of interlocking layers.

14. The single cable transit of claim 13, wherein the u-shaped body comprises:
a front surface;
a back surface opposite the front surface; and
a plurality of holes formed through the u-shaped body between the front surface and the back surface.

15. The single cable transit of claim 14, wherein the compression member comprises:
a pair of front plates;
a pair of back plates connected to the pair of front plates; and
a plurality of bolts connected between the pair of front plates and the pair of back plates;
wherein the plurality of bolts are disposed withing the plurality of holes.

16. The single cable transit of claim 15, wherein the pair of back plates comprise a plurality of internally threaded holes to mate with the plurality of bolts.

17. The single cable transit of claim 15, wherein each of the pair of front plates comprise a first curved projection; and wherein each of the pair of back plates comprise a second curved projection.

18. The single cable transit of claim 17, wherein the u-shaped body comprises:
a front curved channel extending along the front surface between the plurality of holes, the front curved channel configured to receive the first curved projection; and
a back curved channel extending along the back surface between the plurality of holes, the back curved channel configured to receive the second curved projection.

19. The single cable transit of claim 12, further comprises a core connected between the plurality of interlocking layers.

20. The single cable transit of claim 19, wherein the core comprises:
a central cylinder having an exterior surface; and
a plurality of ribs disposed along the exterior surface.
